(19) United States
(12) Patent Application Publication
(10) Pub. No.: US 2013/0286851 A1
(43) Pub. Date: Oct. 31, 2013

(54) COMMON RADIO ELEMENT APPLICATION MANAGER FOR WIRELESS SMALL CELLS

(71) Applicant: Public Wireless, Inc., San Jose, CA (US)

(72) Inventors: Brett Moser, Atascadero, CA (US); Zhanhe Shi, San Jose, CA (US); Nart Bajj, Canyon Country, CA (US)

(21) Appl. No.: 13/926,700

(22) Filed: Jun. 25, 2013

Related U.S. Application Data
(63) Continuation-in-part of application No. 13/444,704, filed on Apr. 11, 2012, now Pat. No. 8,521,223.
(60) Provisional application No. 61/474,705, filed on Apr. 12, 2011.
(60) Provisional application No. 61/568,295, filed on Dec. 8, 2011.

(51) Int. Cl. H04W 24/02

(52) U.S. Cl. CPC H04W 24/02
USPC 370/241.1

(57) ABSTRACT

A multi-modal multi-modulation base station such as a small cell is disclosed. The small cell can include multiple radio devices that can be configured to communicate with user devices using different protocols and different frequencies. The base station includes a backhaul interface to core networks that can also operate according to multiple protocols. A common radio element application manager (CREAM) control operations of the radio devices including core network connectivity, mode-to-mode communications, and synchronization of small cell features. CREAM operations include self-organizing network functions such as automatic neighbor relations, mobility optimization, load balancing, and inter-cell interference coordination.

### CROSS-REFERENCE TO RELATED APPLICATIONS

This application is a continuation-in-part of U.S. application Ser. No. 13/444,704, filed Apr. 11, 2012, which claims the benefit of U.S. provisional application No. 61/474,705, filed Apr. 12, 2011, and U.S. provisional application No. 61/568,295, filed Dec. 8, 2011, all of which are hereby incorporated by reference.

### BACKGROUND

The present invention generally relates to the field of wireless communication systems and to systems and methods for managing wireless small cells.

Growth in wireless communication continues to increase. Demand for data services with high data bandwidth requirements has led to the introduction of multiple modulation techniques for wireless communication, such as Long Term Evolution (LTE), High-Speed Downlink Packet Access+ (HSDPA+), and CDMA2000 1xEV-DO (Evolution-Data Optimized or “EVDO”). Additionally, deployment of small cells such as small cells has become increasingly desirable for providing coverage. Small cells may be deployed, for example, in areas having high user density, such as airports or event venues. A small cell deployment typically has a 100 meter to 1 kilometer radius. Both voice and data modes are desired in small cell deployments. Development of multi-modal multi-modulation capable small cells is complex. Such small cell systems need management of backhaul and core network connectivity as well as advanced features such as capabilities for self-organizing networks.

### SUMMARY

In one aspect, the invention provides a base station, comprising: one or more radio modules operable to establish wireless communications with user equipments using one or more managed cells; a backhaul interface module configured to send data to a core network and receive data from the core network; a common radio element application manager (CREAM) module configured to manage communications between the user equipments and the core network via the radio modules and the backhaul interface, the CREAM module comprising: one or more radio interface modules for managing communications with the one or more radio modules; a radio resource manager module for managing resource of the one or more radio modules and for providing call admission decisions; a mobility processor module for carrying out handover operations to move communications with the user equipments between cells; a core network and inter-cell management module for managing communication with core network nodes and for managing functions between the base stations and other base stations nodes; and a self-organizing network module for configuring and optimizing network operations of the base station.

In another aspect, the invention provides a base station, comprising: one or more radio modules, each of the radio modules operable to establish wireless communications with user equipments using one or more managed cells; a backhaul interface module configured to send data to a core network and receive data from the core network; a processor; and a memory coupled to the processor and storing instructions for execution by the processor, the instructions comprising: one or more radio interface modules for managing communications with the one or more radio modules; a radio resource manager module for managing resource of the one or more radio modules and for providing call admission decisions; a mobility processor module for carrying out handover operations to move communications with the user equipments between cells; a core network and inter-cell management module for managing communication with core network nodes and for managing functions between the base stations and other base stations nodes; and a self-organizing network module for configuring and optimizing network operations of the base station.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a diagram of a small cell deployed in a wireless communications network in accordance with aspects of the invention;

FIG. 2 is a functional block diagram of a small cell in accordance with aspects of the invention;

FIGS. 3 and 4 are a functional block diagrams illustrating various aspects of a common radio element application manager in accordance with aspects of the invention;

FIG. 5 is a state diagram of operational states in a small cell in accordance with aspects of the invention; and

FIG. 6 is a state diagram of operational modes of a cell in accordance with aspects of the invention.

FIG. 7 is a diagram illustrating creation of the modules within a common radio element application manager in accordance with aspects of the invention;

FIG. 8 is a diagram illustrating dependencies between modules within a common radio element application manager in accordance with aspects of the invention; and

FIG. 9 is a flow diagram illustrating load balancing decisions in accordance with aspects of the invention.

### DETAILED DESCRIPTION

The systems and methods disclosed herein can be used with multi-modal multi-modulation small cells. Multi-modal multi-modulation small cells can be configured to provide wireless network connectivity to a plurality of user devices. The user devices can be associated with multiple voice/data network providers that use different frequencies and/or modulation schemes. Multi-modal multi-modulation small cells may include a system manager for backhaul and core network connectivity and for mode-to-mode communications and synchronization of small cell features. The systems and methods disclosed herein may be used to implement such a system manager. For concise exposition, various embodiments are described using terminology and organization of particular technologies, standards, and services. However, the systems and methods described herein are broadly applicable to other technologies, standards, and services.

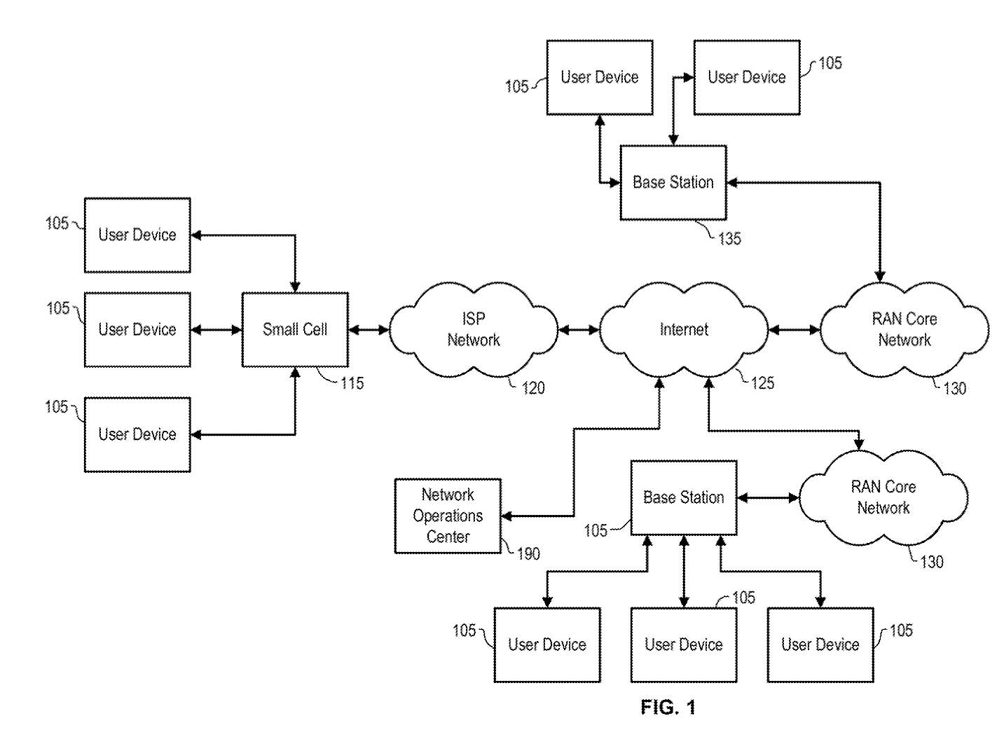

FIG. 1 is a block diagram of a wireless communications network. The wireless communications network includes a small cell 115. The small cell 115 is a small base station and may be deployed to provide coverage for a smaller area than a traditional, or macro, base station. The small cell may also be termed, for example, a small form-factor cell, femtocell, or picocell. For example, the small cell 115 may provide coverage for an office building, hotel, condominium complex, shopping mall, airport, train station, or event venue. Small cells may be used to fill in coverage in indoor environments where signals from outdoor macro base stations do not easily reach. Small cells may also be used to add network capacity in areas where dense mobile device usage can be present, such as airports, train stations, and sports or concert venues.

The small cell 115 may be configured to provide coverage for one or more mobile phone carriers or network providers. The small cell 115 communicates with a radio access network (RAN) core network 130 via a broadband connection provided by an Internet service provider (ISP) network 120. The ISP network 120 provides a backhaul connection for the small cell 115. The ISP network 120 may communicate with the RAN core network 130 directly or indirectly via the Internet 125. The RAN core network 130 provides telecom services to user devices 105. Each of the user devices 105 is subscribed to a respective network provider associated with the RAN core network 130. Some of the user devices 105 may be mobile communication devices, such as mobile phones, wireless modems, or other device that use voice, data, or other communications services. Other user devices 105 may be fixed location devices. Various ones of the user devices 105 may be associated with different network providers and may communicate using different frequencies and communication protocols.

The small cell 115 receives data from the RAN core network 130 via the ISP network 120 and transmits the data to one or more of the user devices 105. The small cell 115 also receives data from the user devices 105 and transmits the data to the RAN core network 130 via the ISP network 120. Alternatively, the small cell 115 may communicate directly with the RAN core network 130.

The small cell 115 can include one or more radio devices that can be remotely configured by a network administrator. The radio devices may be configured to operate using various frequencies (or bands) and communication protocols (or modulation techniques). The radio devices of the small cell may be reconfigured based on demand. Furthermore, the small cell can include extra radio devices beyond what is forecast for current coverage needs. The extra radio devices allow the small cell's capabilities to expand to provide service to a larger number of subscribers and/or carriers. The extra radio devices may also be used as backups that are activated if monitoring systems implemented for the small cell detect that a radio device has failed. Providing reconfigurable radio devices and extra radio devices can provide cost savings by reducing the need for a technician to be deployed into the field to service the small cell.

The wireless communications network also includes base stations 135. The base stations 135 communicate with the RAN core network 130 and also provide coverage to the user devices 105. The small cell 115 may provide coverage in an area that overlaps with coverage areas of the base stations 135. FIG. 1 has been simplified for ease of explanation and a wireless communications network may include additional elements including a plurality of small cells. A wireless communications network may also include additional communication paths.

The wireless communications network also includes a network operations center (NOC) 190. The NOC 190 may be used for managing operation of the small cell 115. A system administrator can remotely configure the small cell 115. According to an embodiment, system administrators can also monitor and manage the network or networks providing backhaul connectivity to the small cell 115.

The small cell 115, in an embodiment, provides self-organizing network functions. For example, the small cell 115 provide operations for automatic neighbor relations, tracking area optimization, RACH optimization, mobility optimization, load balancing, and inter-cell interference coordination.

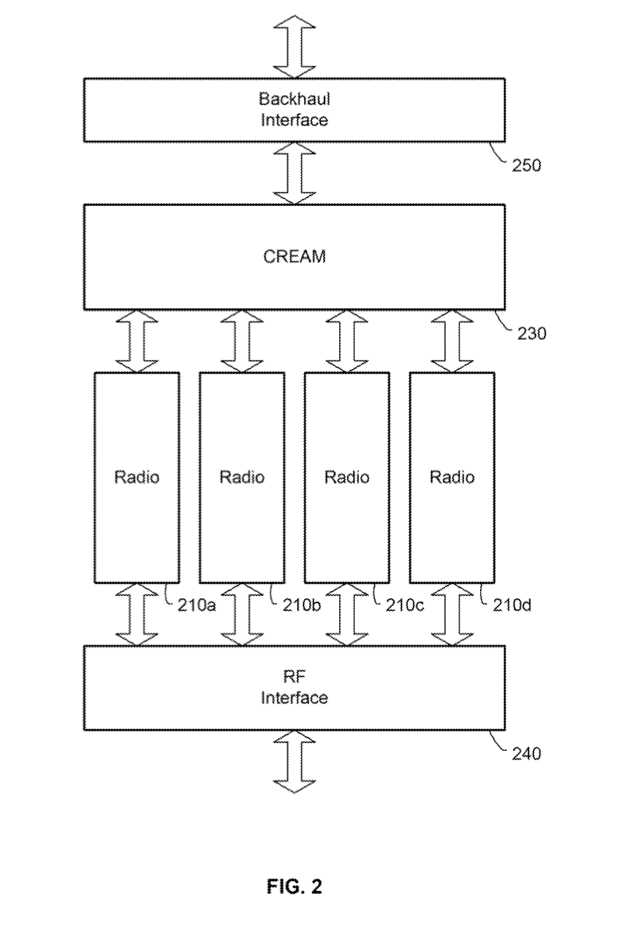

FIG. 2 is a functional block diagram of a small cell according to an embodiment. The small cell may be used to implement the small cell 115 of FIG. 1. The small cell of FIG. 2 includes a radio frequency (RF) interface module 240, a backhaul interface module 250, and a common radio element application manager (CREAM) module 230. The small cell illustrated in FIG. 2 includes four radio devices (modules) 210. However, in other embodiments, the small cell may include greater or fewer radio devices. For example, a small cell deployed in an area that is anticipated to have a high concentration of user devices during peak usage may include more radio devices than a small cell deployed in an area that is anticipated to have a low concentration of user devices. The CREAM module 230 provides an interface that allows a small cell to include multiple radio devices 210 and to manage the interaction of the radios.

The RF interface module 240 provides an interface for radio signals to and from the small cell. The RF interface module 240 couples the radio devices 210 to one or more antennas. The antennas can include a broadband antenna used for transmitting and receiving in the frequency bands that are used for mobile communications. The RF interface module 240 includes circuitry for transmission and reception of the radio signals such as power amplifiers for driving the antennas, low noise amplifiers (LNAs) for amplifying signals received by the antennas, tuners, upconverters, and downconverters.

The RF interface module 240, in some embodiments, combines and splits the radio signals. For example, the small cell may be configured for MIMO or diversity operation. Additionally, the RF interface module 240 may operate in multiple frequency bands. The RF interface module 240 may include modules that are dynamically configurable or adjustable. For example, a power amplifier in the RF interface module 240 may be configured for various predistortion techniques and may have an adjustable bias setting. The bias setting may be chosen to provide an interband and interprotocol optimized setting. In an embodiment, the RF interface module 240 employs digital predistortion (DPD) and crest-factor reduction (CFR) techniques. The combination of DPD and CFR schemes in conjunction with power amplifier bias control can provide high performance, reduce costs, and reduce power requirements.

Each of the radio devices 210 may be configured to support a specific protocol stack. The protocol stack may include, for example, a Radio Resource Control (RRC) layer, a Packet Data Convergence Protocol (PDCP) layer, a Radio Link Control (RLC) layer, a Media Access Control (MAC) layer, and a Physical (PHY) layer. The protocol layers of the radio devices 210 may differ and allocation of functions over the layers may also differ.

The Radio Resource Control (RRC) layer handles the control plane signaling of Layer 3 between the user devices and the Universal Terrestrial Radio Access Network (UTRAN). The UTRAN allows connectivity between the UE and the core network. The UTRAN includes base stations (eNodeBs) and Radio Network Controllers (RNCs). The RRC layer provided functions for connection establishment and release, the broadcast of system information, radio bearer establishment/reconfiguration and release, paging notification and release, and outer loop power control.

The Packet Data Convergence Protocol (PDCP) layer performs IP header compression and decompression, transfer of user data and maintenance of sequence numbers for Radio Bearer.

The Radio Link Control (RLC) layer delivers data to the MAC layer over logical channels. The RLC layer maps these logical channels to transport channels that represent the interface to the physical layer. The RLC layer can provide error correction and can also ensure that data is delivered only one time and in the correct sequence. The RLC layer can also segment data packets delivered by higher layers so that the MAC sublayer receives data of the correct size over the logical channels.

The Media Access Control (MAC) layer coordinates access to the physical medium over which data is transmitted. The MAC layer can include queue in which data for different data streams can be placed until the data is transmitted.

The Physical (PHY) layer provisions transport channels, maps transport channels to the physical interface, provides macro diversity and soft handover. The physical layer can also provide error protection, such as forward error correction and interleaving. The physical layer can also provide for multiplexing and demultiplexing, frequency and time synchronization, power control, and measurements of various characteristics of the physical link, such as frame error rate.

Each of the radio devices 210, in some embodiments, is configured to implement one protocol stack. For example, in the embodiment illustrated in FIG. 2, the first radio devices 210a may be configured to implement a UMTS protocol stack, the second radio devices 210b may be configured to implement a CDMA1X protocol stack, the third radio devices 210c may be configured to implement a EVDO protocol stack, and the fourth radio devices 210d may be configured to implement a LTE protocol stack. In other embodiments, the radio devices 210 may be configured to support a different combination of wireless communication protocols. Additionally, in some embodiments, the radio devices 210 can be reconfigured dynamically based on the types of user devices being served by the small cell.

The radio devices 210 may be provided as software-defined radios (SDRs). An SDR is a programmable radio device that includes a processor for executing signal processing. A variety of different radio protocols (waveforms) can be received and transmitted depending on the software that is executed by the processor of an SDR. An SDR can be rapidly reconfigured to change radio protocols used. In an embodiment, processing circuitry may be shared between radio devices and between radio devices and other modules of the small cell.

The CREAM module 230 manages radio resources of the small cell. The CREAM module 230 provides an interface that allows the small cell to include a plurality of the radio devices 210. Particular embodiments of the CREAM module are further described below.

The backhaul interface module 250 provides an interface to backhaul communications for the small cell. The backhaul connections may vary, for example, depending on the type of network that the small cell will be connected to. For example, the backhaul interface module 250 may include a Data Over Cable Service Interface Specification (DOCSIS) connection, an Asymmetric Digital Subscriber Line (ADSL) connection, a Very-high-bit-rate Digital Subscriber Line (VDSL) connection, a satellite connection, or an optical fiber connection. In some embodiments, the backhaul interface module 250 includes connections for multiple backhaul interfaces. Data received from the network is supplied to the other modules of the small cell via the backhaul interface module 250. Similarly, data from the modules of the small cell is transmitted to the network via the backhaul interface module 250. The backhaul interface module 250 may also provide power distribution and control, environmental monitoring, and local and remote system management support for the small cell.

According to an embodiment, the backhaul interface module 250 can include or be considered an external radio device support system (ERDSS) module that operates with various types of backhaul connections. Interactions between the NOC 190 and the small cell can occur via the ERDSS module. For example, a system administrator can remotely monitor operating status of the small cell, send configuration commands and/or updated software to the ERDSS module to remotely modify the operation of the small cell.

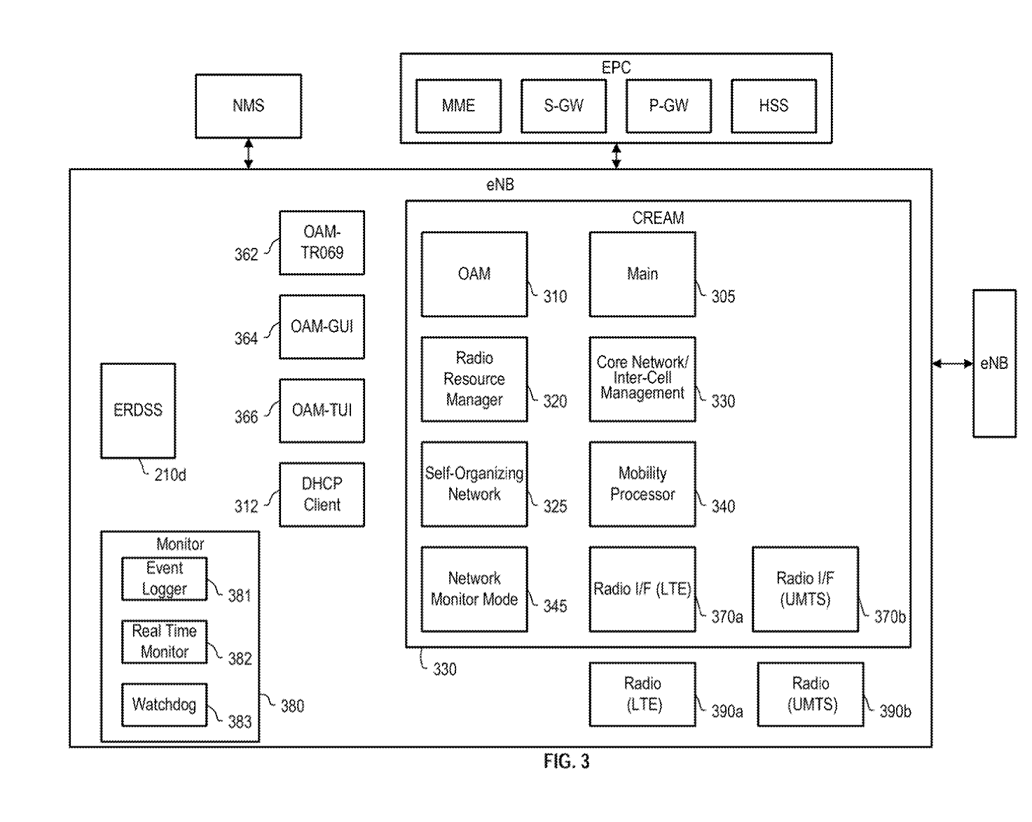

FIGS. 3 and 4 are functional block diagrams of aspects of a CREAM module in accordance with aspects of the invention. The CREAM module of FIGS. 3 and 4 may be used in an embodiment of the small cell of FIG. 2. In FIG. 3, modules that are included in CREAM module and that interact with the CREAM module are shown. In FIG. 4, interfaces between the various modules are illustrated. In the embodiment of FIG. 4, some of the interfaces are Unix sockets (shown as dashed lines) and some of the interfaces are TCP sockets (shown as dotted lines). For concise description, communication between modules may be describe as simply one module sending or receiving a message from another module; however, the communications may include many details that are not described, for example, serializing and deserializing communications and handshake protocols such as acknowledging, error recovery, and re-sending messages. In addition, the modules within the CREAM module may be cognizant of data dependencies. For example, a first one of the modules may rely on another module to allocate a data structure used by the first module. The CREAM module can manage the resources of the associated small cell (or eNB) and its connections. It provides operational control of multiple attached radios (cells) while implementing inter-RAT and intra-RAT handovers, system optimization, and load balancing using SON algorithms. For convenience of presentation, portions of the CREAM module are described using only software terminology but it should be understood that the functions of the CREAM module may also be implemented in hardware or a combination of hardware and software.

The CREAM module, by way of introduction, includes functions providing resource management, operational control, and management of call processing. Example functions for resource management include initializing and configuring the small cell; monitoring resources and performing health and status reporting and fault processing; maintaining a collection of available EPC nodes (MME, S-GW, P-GW, and HSS) and status information on those nodes; maintaining a collection of other eNBs in the network, their managed cells, and status information; establishing and monitoring S1 connections; establishing and monitoring X2 connections; managing multiple baseband PHY elements and radio access protocol stacks; and allocating radio resource elements within each protocol scheduler.

Example functions for operational control include managing configuration items which may be set by a network management systems (NMS) (e.g., via a TR-069 interface); providing OAM functions using a direct user interfaces, a web based GUI, and a text based maintenance terminal; providing identification and authentication of different classes of OAM users (e.g., network operator or diagnostic/test engineer); providing an OAM interface customized for the needs of different classes of OAM users; synchronizing an active running configuration with a configuration stored in non-volatile memory; providing operator control of resource usage; and providing access to error, activity, and alarm logs.

Example functions for management of call processing include managing UE mobility across multiple cells within the same access network; managing UE mobility across multiple cells across different access networks; controlling admission and load-balancing with neighboring cells; load-balancing of core network node usage; and resolving and reporting cell identity conflicts for enforcing neighbors to a cell to have unique PCI.

The CREAM module includes a main module 305. The main module 305 provides a beginning function for the other modules. The main module 305 contains the entry point for the CREAM process. The main module 305 performs allocation of buffer pools for use by CREAM modules. For example, the main module 305 may initially allocate all or most of the memory used by the CREAM process to avoid dynamic allocations and deallocations of memory. The main module 305 also performs creation and initialization of CREAM components. For example, a COAM module and an RRM module may be directly instantiated by the main module 305. The main module 305 also manages release of CREAM components for shutdown of the CREAM process. The main module 305 also provides processing of a main event loop, in some embodiments. The main module 305 may use a watchdog timer module. In some embodiments, the main module 305 spawns separate threads for other modules. The main module 305 may also drives system initialization procedures.

The CREAM module, in the illustrated embodiment, includes a CREAM OAM (COAM) module 310 that manages configuration and monitoring requests between CREAM process components and external systems. For example, the COAM module 310 may manage request for the CPE WAN Management Protocol (OAM-TR069), graphical user interface (OAM-GUI), and terminal user interface (OAM-TUI). Accordingly, the COAM module 310 communicates with COAM clients, such as an OAM-TR069 module 362, an OAM-GUI module 364, and an OAM-TUI module 366. The COAM module 310 includes an OAM interface module 316 that provides interfaces for the COAM clients.

The COAM module 310 may control configurations of other CREAM modules, for example, by routing configuration updates, by loading stored configurations from a file system, or by applying settings to a running configuration. The COAM module 310 can synchronize a stored configuration with changes to a running configuration. The COAM module 310 may also replace the stored configuration with a default configuration. The COAM module 310 may perform integrity checks on stored configuration and alarm history files. Unknown or invalid data model elements found in an integrity check are generally logged and subsequently ignored. The COAM module 310 includes a configuration file manager module 314 that can be used to provide these configuration operations.

The COAM module 310 may also perform integrity checks on requests it receives from the COAM clients. Unknown or invalid data model elements are generally logged and then ignored.

The COAM module 310 may also maintain states of various system alarms. Changes in the states of the system alarms are recorded in the alarm history file. Accordingly, the COAM module 310 manages an alarm history file system, for example, by providing file rotation and deletion of old files. The COAM module 310 may also maintain a log file of operator activity. Additionally, the COAM module 310 may inform the COAM clients of alarm state changes and configuration changes.

The COAM module 310 may also gather statistics from CREAM component modules as requested by the COAM clients. The statistics may include instantaneous statistics and statistics gathered over time windows. The COAM module 310 routes logging and message tracing control commands received from the COAM clients to the other CREAM modules.

The COAM module 310, in some embodiments, controls small cell operational states. Additionally, the CREAM module 310 may control operational modes of cells served by the small cell.

The COAM module 310, in some embodiments, controls small cell operational states. Additionally, the CREAM module 310 may control operational modes of cells served by the small cell.

The CREAM module 330 also uses a DHCP client module 312. The COAM module 310 may have an interface to the DHCP client module 312. The DHCP client module 312 operates as a system DHCP client. The DHCP client module 312 can be used to obtain configuration information from the ERDSS. The DHCP client module 312 is, in an embodiment, spawned by the system monitor module 380. The DHCP client module 312 may be spawned at the request of the COAM module 310. Configuration items are placed in a text file that is read in by the COAM module 310. In such an embodiment, the DHCP client module 312 does not actually configure the network interface, instead the DHCP client module 312 obtains the configuration information and writes it to the local file system 380.

The COAM module 310, in some embodiments, includes a thread monitor. The thread monitor may in interfaces with the system monitor module 380. Monitored threads created within CREAM main module 305 are registered with the thread monitor. Other threads may also be registered with the thread monitor. If a registered thread misses heartbeats then the thread monitor stops sending heartbeat messages to the system monitor module 380.

The CREAM module 310 includes a radio resource manager (RRM) module 320. The RRM module 320 provides control for handover and call admission decision making. Inputs from other modules, such as a self-organizing network (SON) module and a core network and inter-cell management (CNIPM) module, and terminal measurements are used for decisions on handover and call admission. The RRM module 320 interfaces with the radio protocol interface layer (for example, using an LTE radio library) to communicate with associated cells and ultimately UEs. The RRM module 320 can allocate control and data downlink and uplink channels through schedulers in the MAC layers associated with the radio devices 210.

Operations performed by the RRM module 320 include maintaining a list of cells owned by the small cell and for each owned cell, maintaining black lists and white lists of neighbor cells. The RRM module 320 also performs admission control for UE attachments, incoming handovers, and connection setups. The admission control can be QoS based. Handover decisions, for example, trigged by load balancing, by mobility, or by system shutdown, are also performed by the RRM module 320. The RRM module 320 can also manage connectivity of the protocol stacks of the radio devices 210 with each other. The RRM module 320 can also process self-configuration values received from other modules (e.g., handover thresholds, handover time-to-trigger, cell PCI, cell tracking area, PRB allocation, and RACH configuration).

The CREAM module includes the self-organizing network (SON) module 325. The SON module 325 provides functions for monitoring system operation and adjusting parameters to effect auto-configuration, self-healing, and optimization requirements. Operations performed by the SON module 325 include RACH optimization procedures, tracking area update procedures, mobility performance adjustments (for example, updates to the RRM modules handover decision parameters to adjust for early, late, and wrong cell handover failures).

The SON module 325 can also be used to setup cell radius conditions based on a specific QoS profile per user and per small cell. The SON module 325 can also be used to manage load balancing within the small cell itself. The SON module 325 can also be used to manage load balancing between radio access technologies. The SON module 325 provides initial setup and self-configuration and dynamic control. The SON module 325 can also provide operations for inter-cell interference coordination.

In an embodiment, the SON module 325 can use demand-based/usage-based self-learning algorithms and predictive algorithms to dynamically reconfigure the radio devices 210. The predictive algorithms can anticipate usage conditions so that the small cell can be configured to meet the anticipated usage. The prediction algorithms can make predictions including information event information from a third-party source, historical data collected by the small cell, or data from other base stations in a coverage area.

The SON module 325 can reconfigure the radio devices of the small cell to use different wireless protocols based on capacity resource allocations. For example, a wireless network provider can contract with the small cell provider to provide a specific base capacity for the wireless network provider's subscribers. The wireless network provider can also contract with the small cell provider to provide additional capacity, if available, in peak usage situations where the wireless network provider's subscribers have utilized the base capacity.

The SON module 325 can also coordinate resource allocation between small cells. For example, in some embodiments, the SON module 325 can send signal information to adjacent small cells (or other NBs). By sharing utilization information among small cells, the SON module 325 can better anticipate the demands on the small cell and to reconfigure to small cell accordingly.

The CREAM module includes a core network and inter-cell management (CNIPM) module 330. A core-network function of the CNIPM module 330 is to contain and track status on the collection of registered core network nodes (MME/SGWs for LTE). For LTE support, the CNIPM module 330 interfaces, via an LTE radio interface module 370a, with the LTE radio module 390a to operate an S1-MME link. In some embodiments, most terminal-related 51 interactions are handled internal to radio modules 390, thus the core-network functions provided by the CNIPM module 330 are limited. The CNIPM module 330 may be more involved in the interaction with core network nodes in other embodiments. Additionally, in some embodiments, functions of the CNIPM module 330 vary between the particular protocols provided.

The CNIPM module 330 also performs inter-cell management functions. The CNIPM module 330 contains and tracks statuses on a collection of peer eNB nodes. For LTE, for example, the CNIPM module 330 may use the LTE radio module 390a for maintaining connectivity with the eNB peers. The CNIPM module 330, in some embodiments, operates a custom interface (X2′) to provide features not supported by the X2 standard for connections established with other CREAM-enabled small cells. At initialization, the CNIPM module 330 broadcasts its presence over the X2′ interface to locate other CREAM-enabled small cells and establish communications with them.

In an embodiment, the CNIPM module 330 performs intra-radio transfers between radio devices within the small cell, that is, the transfer of a UE from one radio device to another radio device. The intra-radio transfers can be between radio devices that are operating using the same frequency and modulation, that are operating using the same frequency but different modulation, that are operating using the same modulation but different frequencies, or that are operating using different frequencies and different modulation. For example, the CNIPM module 330 may facilitate handoffs between a 3G and a 4G network.

The CREAM module includes a network monitor mode (NMM) module 345. The NMM module 345 provides an interface to the physical layer. In an embodiment, this is a message-based interface implemented over a PCI bus. The interface may be used to provide cell signal measurements from the attached radios to the SON module 325 for interference and signal quality managements. For example, the NMM module 345 may implement the Femto Application Platform Interface, PHY mode control interface (FAPI P4).

The CREAM module includes a mobility processor (MP) module 340. The MP module 340 oversees actions used to carry out handover operations. The module 340 also maintains information used to support PCI conflict detection. The MP module 340 interfaces directly with radio protocol interface layers (e.g., the LTE radio module 390a) to managed handover signaling. Operations provided by the MP module 340 include managing a state machine for handover processes and determining if the handover uses X2, S1, or Inter-RAT operations. The MP module 340 may also build and maintain graphs of known cells and their neighbor relationships and maintain information regarding ownership for all known cells. The cell graph is constructed using information received from the RRM module 320 (for owned cells and cells detected from UE measurements) and from eNB configuration announcements received via the CNIPM module 330 from the X2 interface.

The MP module 340, in an embodiment, provides automatic neighbor list operations, for example, using reported UE measurements. The MP module 340 may also perform PCI selection.

The CREAM module includes a system monitor module 380. The system monitor module 380, in the illustrated embodiment, includes an event logger (EL) module 381, a real time monitor module 382, and a watchdog timer module 383. The system monitor module 380 provides for the CREAM module. The system monitor module 380 receives information from other modules and processes. The received information can be logged. The received information can also be analyzed, for example, to detect faulty operation of another module. The real time monitor module 382 may use a TCP socket that outputs configured log messages to a connected client.

The system monitor module 380, in an embodiment, uses a process started by an initialization service (e.g., an init process) and starts other CREAM processes (e.g., main module 305, OAM-TR69 module 362 and OAM-GUI module 364 processes, and radio protocol stack processes). The system monitor module 380 provides a UNIX domain socket interface to receive heartbeat messages and a UNIX domain socket for logging and control messages from CREAM processes. At startup, the system monitor module 380 reads a configuration file to determine the managed process hierarchy and properties. Example operations that may be provide by the system monitor module 380 include: unified CREAM logging functions provided through the EL module 381; management of a hardware watchdog timer; startup of CREAM processes; restart of CREAM processes that miss too many successive heartbeats; notification of parent processes when a child is restarted; run-time adjustment of process configuration (e.g., starting and stopping of child processes at the request of connected CREAM processes); and system reboot when a system critical process misses too many successive heartbeats.

The EL module 381 collects log messages generated by the various CREAM modules and process components. The messages may be pushed to the EL module 381 or the EL module may alternatively or additionally poll modules for information. The log messages or information about the messages may be stored in a local file system 380. The local file system 380 may also be used to store a CREAM software image, stored and factory configuration files, log files, and alarm history files. Event information may be stored in rotation with older information deleted when new information is added. The stored event information is accessible to clients (e.g., OAM-TR069, OAM-GUI, and OAM-TUI). The clients generally have read-only access rights.

The EL module 381 can listen for real-time logging The EL module 381 may listen on a well-known port for TCP connections. When a real-time logging connection is established, a real-time logging session is created inside the EL. The session can be initialized using current default log filter settings. The session may be identified by a local ephemeral port number assigned to the connection. Specific log filter settings may be configured for this session using messages on an interface connection to the system monitor module 380. Once a specific setting is configured, the session is no longer tied to the default settings and uses a session-specific configuration for the life of that session.

The EL module 381, in an embodiment, maintains a master filter that is applied to all received log messages before applying the specific end-point filter (file log or real-time logging session). The master filter is maintained by the EL module 381 and is updated when specific logging end-point (file log, real-time logs) filters are changed. When changes to the master filter are made, the new master filter is automatically sent out to all connected logging clients so that they may update their internal log generation settings as appropriate.

Real-time logging connections, in an embodiment, are treated as a read-only ASCII stream from the EL module 381 to the associated client. The first message sent after connection establishment contains a real-time logging session identifier. Subsequent messages are log message entries that has passed the active filter for the session. Any data received on the socket from the client may be quietly ignored.

The OAM client modules that interface with the CREAM module via the COAM interface module 310 include an OAM-TR069 client module 362. The OAM-TR069 client module 362 implements a TR-069 interface to NMS (or an automatic configuration system (ACS)). TR-069 defines the CPE WAN management protocol (CWMP) protocol for remote management of end-user devices. The OAM-TR069 client module 362 includes an embedded web server or makes use of a web server in another module (for example, the OAM-GUI module 364). When the OAM-TR069 client module 362 and the OAM-GUI module 364 include web servers, the servers may be configured to use different HTTP and HTTPS ports. In an embodiment, the COAM interface module 310 also implements the TR-111 protocol. TR-111 provides mechanisms for applying TR-069 to remote management of home networking devices.

Operations provided by the OAM-TR069 client module 362 include conducting TR-069 session with an NMS, building a vendor configuration file and downloading it to the NMS, and uploading a vendor configuration file from NMS, decoding it, and setting corresponding configuration values using the COAM interface module 310. The OAM-TR069 client module 362 may also upload a software image file to the eNB, store the image file in an appropriate location, and initiate a software update process. Based on operator requests, the OAM-TR069 client module 362 sends parameter get and set commands to the COAM module 610. The OAM-TR069 client module 362 may also provide network and device diagnostic operations.

The OAM client modules also include an OAM-GUI client module 364. The OAM-GUI client module 364 includes web server (for example, a stripped down build of Apache for Cavium Linux or a custom server component built around libwww or similar library) and a collection of web pages implementing the operator's user interface.

Operations provided by the OAM-GUI client module 364 include building a vendor configuration file and download it to a user-specified location and uploading vendor configuration file from a user-specified location to the eNB, decoding it, and corresponding configuration values using the COAM interface module 310. The OAM-GUI client module 364 may also upload a software image file to the eNB, store the image file in an appropriate location, and initiate a software update process. Displays provided by the OAM-GUI client module 364 include a snapshot of an event log, a snapshot of a syslog, an alarm history, and a current alarm status. Via the OAM-GUI client module 364, periodic polling and monitoring of user-specified readable configuration and status values and modification of writable configuration values are provided. The OAM-GUI client module 364 may also provide network and device diagnostic operations.

The OAM client modules also include an OAM-TUI client module 366. The module has a text-only shell and provides a set of command-line tools. The tools may be used to build a vendor configuration file, decode a vendor configuration file, and perform bulk and individual updating of configuration parameters. Additional example tools include commands to transfer of files onto and off of the CREAM file system, read and write partitions of non-volatile memory in the small cell, initiate software updates, view event, alarm, and system logs, view alarm status, and display configuration values and statistics. In some embodiments, a direct reboot of the eNB may be performed via the OAM-TUI client module 366.

The modules within the CREAM module, in an example embodiment, are executed as software or firmware on a programmable processor (including multiple processors and processors with multiple cores). Various combinations of the CREAM modules may execute concurrently. For example, a boot-loader may initiate an operating system supporting multiprocessing, such as SMP-Linux, to use multiple processing cores available cores the CREAM processor. Accordingly, some processes may run as standard parts of the Linux operating environment.

In the example embodiment, system processes include a collection of user and kernel processes that run as a standard part of the Linux operating environment. Example processes include init, kflushd, kupdate, kpiod, kswapd, syslogd, sshd, and getty. The init process, in an embodiment, is configured to start the process for the system monitor module 380. The system monitor module 380 can then take responsibility for resetting (“kicking”) a hardware watchdog timer such that if the system monitor module 380 is not operating properly (e.g., it hangs or exits) the CREAM module 330 reboots. The system monitor module 380 can also start the other CREAM processes and track heartbeat messages generated by those processes. The system monitor module 380 may be limited to execution on certain cores in a multiprocessor implementation. The CREAM module 330 and other associated modules may execute as a multi-threaded tasks. The main module 305, in an embodiment, starts a default event-loop thread under which other CREAM modules execute. The CREAM modules may create additional threads as needed according to various embodiments.

The COAM client modules, in the example embodiment, use a collection of processes to provide the functions identified for the TR-069-based OAM interface, the web-based OAM interface, and the text-based OAM interface. The three OAM interfaces communicate with the CREAM module via the COAM interface module 310. A process for the OAM-TR069 client module 362 generally is always running. Although the process may include multiple threads, the threads may be restricted so that at most one instance of this process is active at any given time. The process for the OAM-TR069 client module 362 includes an interface that acts as a TR-069 client for communicating with an NMS and another interface that acts as a COAM client. The process for the OAM-GUI client module 364 includes a web server and back-end web pages implementing a graphical user interface. The back-end web pages act as a COAM client to communicate with the CREAM module. The web server is always running and may use multiple threads or multiple server processes to handle web requests. The server is configured to accept HTTP and HTTPS connections on the standard ports for those protocols. The process for the OAM-TUI client module 366 includes a collection of command-line tools that may be used, for example, by a software or test engineer. The processes produced by OAM-TUI client module 366 depend on what commands have been issued by the user. The processes produced run only until the requested function completes or until the user disconnects from the terminal.

In a system with multiple processing cores, some processes may be configured to only run on a subset of the available cores. For example, in a processor with n cores labeled 0 to n−1, system processes and threads created by CREAM modules (except threads for the radio protocol) are configured to run using only cores 0 and 1, processes for COAM client modules are configured to run on core 0, and threads implementing L3/L2 radio protocols for each configured cell are assigned to a single core dedicated to processing for that cell. For example, the RRM module 320 may allocate processes for each configured cell to an available core from cores 2 through n−1. Some modules may execute as separate processes rather than as threads.

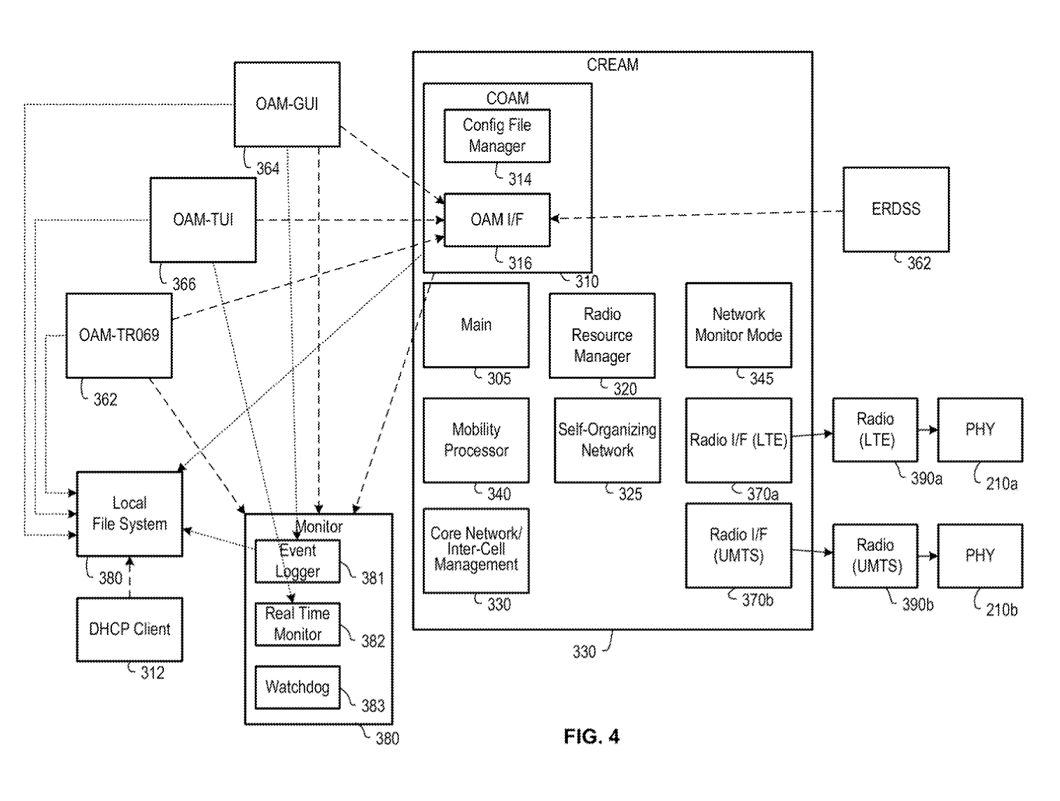

FIG. 5 is a state diagram of operational states in a small cell in accordance with aspects of the invention. In the embodiment of FIG. 5, transitions between states and associated events may be processed, for example, by the CREAM module of FIGS. 3 and 4. The small cell begins in an initializing state 505. In the initializing state 505, functions of the CREAM module include loading configuration files and initializing other components. Startup self-tests may also be performed in the initializing state 505.

After initialization, the small cell enters an offline state 510. In the offline state 510, the small cell is idle and has no cells that are active. The CREAM module may perform various functions in the offline state 510. The various functions can be considered to be substates of the offline state 510. Substates may be associated with events that lead the CREAM module to enter the offline state 510. In an offline-testing substate, the small cell performs self-tests. In an offline-updating substate, the small cell applies a new firmware image. The firmware image may be for use by the CREAM module or other modules of the small cell. In an offline-faulted substate, the small cell has detected a system failure that prevents any access network service from being provided.

The small cell transitions from the offline state 510 to an online state 520 to provide network services. The online state 520 is the normal operational state of the small cell. In the online state 520, individual cells of the small cell may be active or inactive. The online state 520 may also have substates. In an online-degraded substate, the small cell is operating but has detected a failure that degrades services provided by the small cell. For example, the small cell may have detected that one cell is not operations but that some cells are still able to provide access network services.

The small cell may transition from the online state 520 to a releasing state 525. In the releasing state 525, the small cell attempts to gracefully release all served users. The small cell may enter the releasing state 525 after detecting a need to go offline, for example, due to a fault. The small cell returns to the offline state 510 from the releasing state 525.

The small cell may also transition from the online state 520 to a shutdown/restart state 530. In the shutdown/restart state 530, the small cell ends all network services and restarts or shuts down.

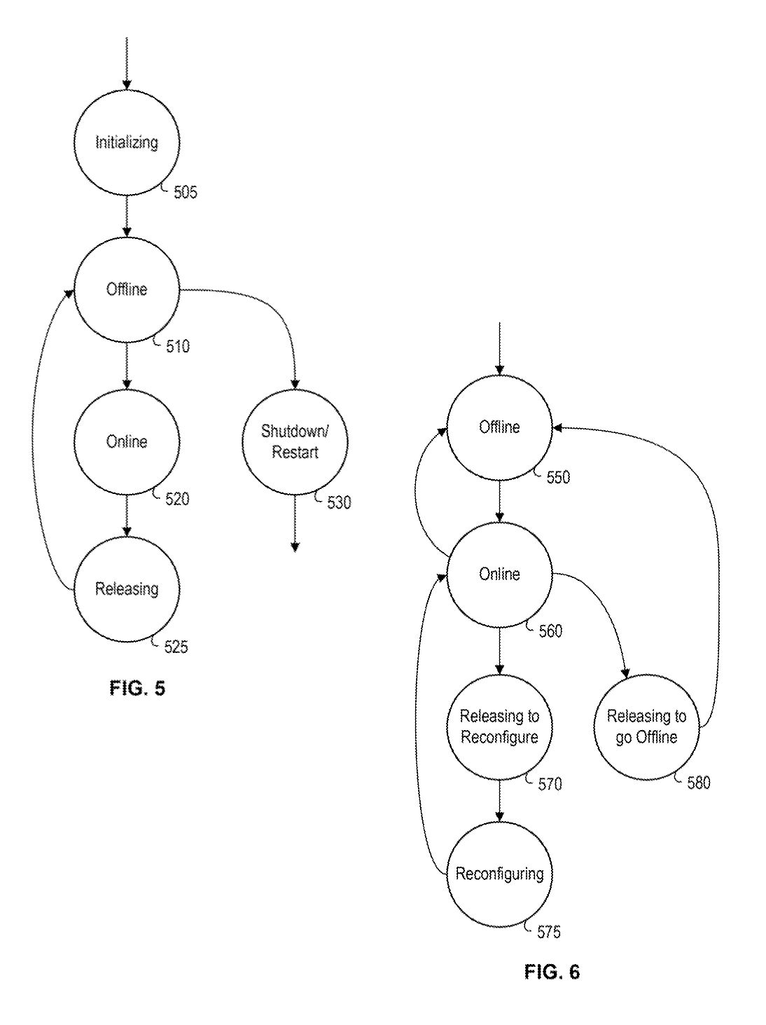

FIG. 6 is a state diagram of operational modes of a cell in accordance with aspects of the invention. In addition to the states of a small cell illustrated in FIG. 5, the cells of the small cell operate in various modes. The operational modes in the embodiment of FIG. 6 include an offline mode 550. The operational modes of the cells of a small cell are generally independent.

When a cell is established, it generally begins in an offline mode 550. When a cell is in the offline mode 550, the small cell is not transmitting in that cell.

The small cell may perform various functions for a cell in the offline mode 550. The various functions can be considered to be sub-modes of the offline mode 550. Sub-modes may be associated with events that lead to entering the offline mode 550. In an offline-standby sub-mode, the cell is available for automatic activation, for example, to serve additional capacity needs. In an offline-faulted sub-mode, the small cell has detected a system failure that prevents normal operation of the cell.

The cell may transition from the offline mode 550 to an online mode 560 to provide network services.

The cell may transition from the online mode 560 to a releasing-to-reconfigure mode 570 or a releasing-to-go-offline mode 580 or return to the offline mode 550.

When the cell is in the releasing-to-reconfigure mode 570, the small cell does not accept new users in the cell. The small cell also attempts to gracefully release all served users. When the cell releases any served users and becomes idle, it transitions to a reconfiguring mode 575. In the reconfiguring mode 575 configuration changes are applied. The cell is then returned to the online mode 560.

When the cell is in the releasing-to-go-offline mode 580, the small cell does not accept new users in the cell. The small cell also attempts to gracefully release all served users. When the cell releases any served users and becomes idle, it transitions to the offline mode 550.

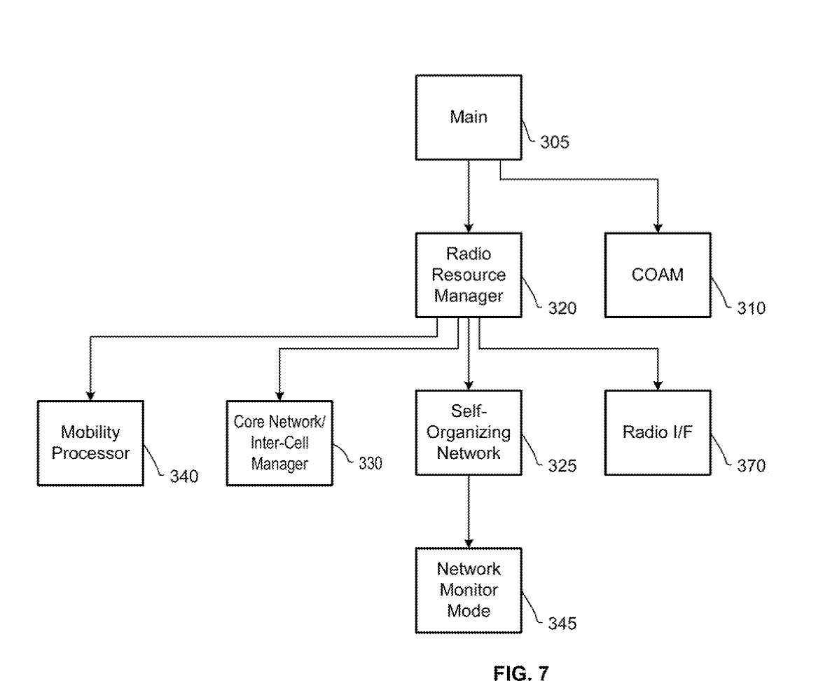

FIG. 7 is a graph of creation of the modules within the CREAM module in accordance with aspects of the invention. In the embodiment of FIG. 7, at startup, the main module 305 instantiates the RRM module 320, and the COAM interface module 310. The RRM module 320 in turn instantiates the SON module 325, the MP module 340, the CNIPM module 330, and the radio protocol interface modules 370. The SON module 325 instantiates the NMM module 345. A module is considered to be the ‘controller’ module of any modules it directly instantiates. The controller modules are responsible for both the initialization and cleanup (shut down) of the modules they control. In other embodiments, which modules are controller modules and the modules they control may differ from the embodiment of FIG. 7.

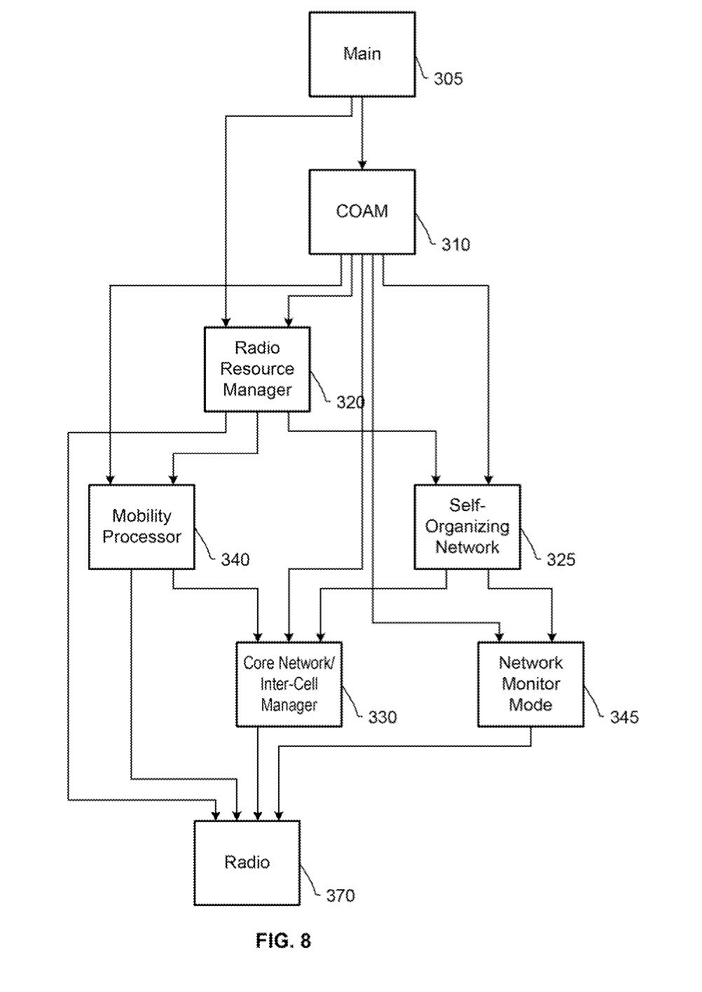

FIG. 8 shows a dependency tree for modules within the CREAM module. The dependency tree of FIG. 8 is similar to the creation graph of FIG. 7 but show additional dependencies between the modules after the instantiations show in FIG. 7. In other embodiments, the dependencies between modules may differ from the embodiment of FIG. 8.

The dependencies shown in FIG. 8 are for an implementation where the COAM clients (OAM-GUI, OAM-TR069, and OAM-TUI) and the CREAM module co-exist on a processor, and the ERDSS runs on a separate processor. The COAM clients expect the CREAM task to create the socket to which they connect to establish the COAM interface to the CREAM module. If the socket does not exist, the COAM clients and the CREAM module will retry periodically until able to establish a connection.

The module dependencies shown in FIG. 8 correspond to interfaces between the modules. In one embodiment, each of the modules that interacts directly with another module has a specific interface to use for that interaction and there are no shared interfaces. For example, the RRM module 320 interacts with the CNIPM module 330 and the MP module 340 also interacts with the CNIPM module 330. Accordingly, there is one interface between the RRM and the CNIPM module 330 and another interface between the MP module 340 and the CNIPM module 330. In an embodiment, modules that are lower in the dependency hierarchy provide the interface for modules higher in the hierarchy.

Many operations provided by a small cell include a sequence of steps. The CREAM module may perform several system-level sequences for operation of the small cell, for example, to handle system-wide operations. The sequences will be described with reference to the common radio element application manager described above. The sequences may also be performed by alternative devices. Example sequences include resource management sequences that operate to activate and delete radio resources and to add and remove connections to network nodes. Further example sequences include operational control sequences that operate to control CREAM modules during OAM control operations. Further example sequences include call processing sequences for processing UE-related activity. Further sequences include self-organizing network sequences that may include inter-module signaling involved in SON-related activity processing.

Example resource management sequences include sequences for managed cell activation, radio interface cell setup, radio interface cell reconfiguration, managed cell removal, cell deactivation, eNB peer cell addition, eNB peer cell removal, eNB peer cell deactivation, neighbor addition, and neighbor removal.

The activate managed cell sequence is performed to active a cell managed by the small cell. The COAM module 310 sends cell activate command to the RRM module 320. The RRM module 320 requests a managed cell configuration structure from the MP module 340. The request includes, implicitly or explicitly what type of cell (e.g., a cell using the LTE protocol) is to be activated.

The activate managed cell sequence may begin while the COAM module 310 is still loading the CREAM configuration file. If so, the RRM module 320 adds the managed cell to an activation pending list. The RRM module 320 can then continue processing configuration value set commands received from the COAM module 310 for the managed cell. When loading the configuration completes, the COAM module 310 sends an indication of the completion to the RRM module 320. The RRM module 320 then performs the following steps for each cell on the pending activation list. If the COAM module 310 was not loading the CREAM configuration file when the activate managed cell sequence started, the following steps are performed without adding the cell to the activation pending list and subsequent indication of completion.

The RRM module 320 stores a set of custom data to be used in callbacks from the radio interface module 370 (in an embodiment with multiple radio interface modules, the RRM module 320 interacts with one of the radio interface modules appropriate for the type of cell) for this cell. The data may be stored, for example, in the local file system 380. The RRM module 320 requests a reference to the managed cell configuration object for the cell from the radio interface module 370. If the returned reference is to an object that is different from the one the RRM module 320 had previously or the RRM module 320 did not have an object (e.g., first activation of the cell), the RRM module 320 stores the reference and merges prior cell settings into the managed cell configuration object. The RRM module 320 then informs the MP module 340 that the contents of the configuration structure for the managed cell are ready for use.

The radio interface cell setup sequence may include initializing the radio protocol stack (radio module) for use in a cell managed by the small cell. RRM module 320 signals a cell setup request to the radio interface module 370. If the protocol stack (e.g., LTE) has not been initialized, the radio interface module 370 sends initialization messages to the radio module 390. The initialization messages may include messages for the various protocol layers (e.g., MAC, PDCP, RLC, GTP-U). Responses to initialization messages can include status messages including information about use of the radio protocol.

After the protocol stack is initialized, the radio interface module 370 sends a cell setup request to the radio module 390. The radio interface module 370 then receives a cell setup response from the radio module 390. The radio interface module 370 sends an MME status indication (Active) to the CNIPM module 330 for each MME that is configured. The radio interface module 370 also sends the cell status indication to RRM module 320. The radio interface module 370 sends the cell status indication to the MP module 340. The radio interface module 370 sends the cell status indication to the CNIPM module 330.

The radio interface cell reconfiguration sequence may be initiated, for example, by operator initiated configuration changes via the COAM module 310 and internally generated self-configuration changes caused, for example, by SON algorithms. The radio interface module 370 receives a cell reconfigure request from the RRM module 320. The radio interface module 370 can determine whether the request is for an advanced or a basic reconfiguration. If the reconfiguration is a basic reconfiguration, the radio interface module 370, in an embodiment, immediately (or shortly aft receipt) commences the reconfiguration with an associated radio module. If the reconfiguration is an advanced reconfiguration, the RRM module 320 notifies the COAM module 310 of the need for cell reconfiguration. When the COAM module 310 receives the cell reconfiguration indication, it can begin a graceful or an immediate change to the reconfiguration state. Whether the change is graceful or immediate can be based on configuration of the managed cell.

The radio interface cell reconfiguration sequence includes the RRM module 320 sending a cell reconfiguration request to the radio interface module 370. The radio interface module 370 determines if advanced or basic operation is needed based on the parameters that are to be changed. Indicates the result of that determination to the RRM module 320 as a return code.

If advanced reconfiguration, the radio interface module 370 internal state is updated to reflect that an advanced reconfiguration in progress. The RRM module 320 informs the COAM module 310 of the need for advanced cell reconfiguration. The COAM module 310 begins graceful or immediate cell shutdown as appropriate.

If basic reconfiguration, the radio interface module 370 sends a cell reconfiguration request to the radio module. The radio module reconfigures its protocol stack and responds with a cell reconfiguration response.

The managed cell removal sequence is used to remove a cell (e.g., created by the managed cell activation sequence) from the small cell. The COAM module 310 can be directed by an OAM operator to delete a cell. The COAM module 310 finds that graceful shutdown is disabled and thus sends the remove command immediately to the RRM module 320. Otherwise, the COAM module 310 can gracefully shutdown by signaling shutdowns and waiting for completion before removing the cell.

The RRM module 320 communicates with the radio interface module 370 to remove the cell from operation. The radio interface module 370 performs signaling with the protocol stack in the corresponding radio module 390 to deactivate cell transmissions. The RRM module 320 releases resources associated with the removed cell. The RRM module 320 informs the MP module 340 of cell removal. The RRM module 320 informs SON of cell removal. The SON module 325 informs the CNIPM module 330 of the cell removal. The CNIPM module 330 releases connections for relevant X2 peers (alternatively, the radio module 390 may release the connections). The radio module 390 sends an indication to the radio interface module 370 that cell delete processing has completed. The radio interface module 370 sends a cell status indication to the RRM module 320 indicated the cell is no longer active. The radio interface module 370 also sends cell status indication to the MP module 340. The radio interface module 370 also sends cell status indication to the CNIPM module 330.

The deactivate cell sequence is used to switch a cell to an inactive state. The COAM module 310 directs the RRM module 320 to deactivate a managed cell. The RRM module 320 commands the radio interface module 370 to delete the cell. The radio interface module 370 sends the cell delete request to the radio module 390. The RRM module 320 notifies the SON module 325 that the managed cell is deactivated. The radio module 390 sends a cell delete response to the radio interface module 370. The radio interface module 370 notifies the RRM module 320 that the cell is removed. The radio interface module 370 notifies the MP module 340 that the cell is removed. The radio interface module 370 notifies the CNIPM module 330 that the cell is removed. The CNIPM module 330 deactivates the managed cell and informs X2 peers of the updated cell status.

The eNB peer cell adding sequence can be used to add a cell to the small cell's set of peer cells. The peer cell may be a remote cell at another eNB or may be a local cell. If the peer cell to be added is a statically configured remote cell, the COAM module 310 directs the CNIPM module 330 to add an eNB peer. If the peer cell to be added is a locally managed cell, the RRM module 320 notifies the SON module 325 of the newly activated cell. The SON module 325 then notifies the CNIPM module 330 of the activated cell. If the peer cell is dynamically configured because of a neighbor relation, the MP module 340 notifies the CNIPM module 330 of the new neighbor cell.

The CNIPM module 330 sends a request to the radio interface module 370 to initiate X2 setups between the added cell and its peers. For each peer relationship the radio interface module 370 requests the radio module 390 to perform the X2 setup request. The radio module 390 sends a response to the radio interface module 370 for each request with the result of the requested X2 setup. The radio interface module 370 sends a response to the CNIPM module 330 for each X2 setup request.

An ‘X2 eNB Configuration Update’ procedure can be executed to notify any affected peers of the new cell.

The eNB peer cell removal sequence can be used to remove a cell in another eNB from the small cell's set of peer cells. The CNIPM module 330 is notified of the cell removals. The source of the notification can vary with the type of peer being removed. If the peer eNB to be removed is a statically configured remote eNB, the COAM module 310 directs the CNIPM module 330 to remove the peer. If the peer cell to be removed is a locally managed cell, the RRM module 320 notifies the SON module 325 of the newly deactivated cell. The SON module 325 notifies the CNIPM module 330 of the newly deactivated cell. If the peer cell to be removed is a remote neighbor, the MP module 340 notified the CNIPM module 330 of the neighbor removal.

The CNIPM module 330 sends a request to the radio interface module 370 to delete X2 setups between the added cell and its peers. For each peer relationship the radio interface module 370 requests the radio module 390 to perform the X2 delete request. The radio module 390 sends a response to the radio interface module 370 for each request with the result of the requested X2 delete process.

The CNIPM module 330 starts the ‘X2 eNB Configuration Update’ procedure to notify affected peers of the removal of the cell.

The eNB peer cell deactivation sequence can be used to remove a cell in another eNB from the small cell's set of peer cells. The radio interface module 370 signals the CNIPM module 330 that a managed cell is deactivated. For each peer of the deactivated cell, the CNIPM module 330 signals the radio interface module 370 to remove the X2 peer. The radio interface module 370 sends a peer removal message to the radio module 390 and receives a response message from the radio module 390.

The neighbor addition sequence can be used to update the small cell's neighbor list. The COAM module 310 directs the MP module 340 to add a static neighbor. The MP module 340 notifies the RRM module 320 that a neighbor cell is available. The MP module 340 notifies the CNIPM module 330 that a neighbor cell is available. The CNIPM module 330 initiates an ‘S1-eNB Config Lookup’ procedure to determine the eNB's transport network configuration. The CNIPM module 330 initiates an ‘Add eNB Peer’ procedure to setup an X2 connection and send the appropriate eNB configuration updates.

The neighbor removal sequence can be used update to the small cell's neighbor list. When the MP module 340 receives a command to remove a neighbor from the COAM module 310, the MP module 340 notifies both the RRM module 320 and the CNIPM module 330 of the removal. The CNIPM module 330 initiates a ‘Remove eNB Peer’ procedure to delete the associated X2 connections and notify affected X2 peers of the managed cell of the removal of the neighbor.

An S1 link status sequence can be used update link status based on messages from the radio modules. When a S1AP_OAM_S1AP_LINK_STATUS_IND message is received the radio interface module 370 decodes the message and sends an indication to the CNIPM module 330. The CNIPM module 330 can raise or clear an MME status alarm depending on the link status.

Example operational control sequences include sequences for CREAM startup, CREAM shut down, operational mode changes, factory configuration restoration, software updates, cell reconfiguration, and control of performance monitoring.

The CREAM startup sequence can be used to initiate processes for the various CREAM modules and interfaces between modules. In an embodiment, the main module 305 instantiates the COAM module 310 and the RRM module 320. The RRM module 320 instantiates the radio interface module 370 and the SON module 325. The SON module 325 instantiates the NMM module 345. The RRM module 320 instantiates the CNIPM module 330 and the MP module 340.

The main module 305 registers with the COAM module 310 for function callbacks.

The main module 305 initializes the RRM module 320. The RRM module 320 registers itself with other components (e.g., the MP module, the SON module, the CNIPM module, and the radio interface modules) for callback functions. The RRM module 320 initializes radio the radio module 390 and the SON module 325. The SON module 325 registers with the NMM module for callback functions. The SON module 325 initializes NMM module.

The RRM module 320 initializes the MP module 340. The MP module 340 registers itself with other components (e.g., the CNIPM module and the radio interface modules) for callback functions. The CNIPM module 330 is also initialized.

The RRM module 320 begins reading static radio protocol configuration files and applying settings from the configuration files to the radio interface modules. The RRM module 320 sends status (e.g., initialization in progress, initialization success, or initialization fail) to the main module. If the RRM module 320 performed a successful asynchronous configuration file read, an initialization complete indication is sent to the main module 305.

The main module 305 initializes the COAM module 310. The COAM module 310 registers itself with other components (e.g., the RRM module, the MP module, the SON module, the NMM module, and the CNIPM module) for callback functions. The COAM module 310 starts asynchronous read of a stored configuration file (or read of a factory configuration if a stored configuration does not present) and returns initialization in progress success code back to the main module 305. The COAM module 310 continues reading configuration and applying the settings. When the configuration file processing completes, the COAM module 310 enables the OAM interface module 316. The COAM module 310 also signals initialization completion to the main module 305.

The main module 305, after receiving indications of successful initialization completion from the COAM module 310 and the RRM module 320, directs the COAM module 310 to begin a dynamic configuration procedure (e.g., using DHCP). If the current configuration has DHCP disabled and static configuration enabled then the COAM module 310 skips the DHCP client related steps. Otherwise, the COAM module 310 commands the system monitor module to start the DHCP client. The COAM module 310 checks for DHCP client configuration file updates. Using values from the active configuration, the COAM module 310 configures the associated network interfaces (e.g., on a processor module that executes CREAM processes). Upon completion, the COAM module 310 sends a configuration complete indication to the main module 305.

The main module 305, after receiving the configuration completion indication from the COAM module 310, instructs the COAM module 310 to begin running system self-tests. After the system self-tests complete, the COAM module 310 indicates results to the main module 305. The main module 305 the issues system activation command to the COAM module 310. The COAM module 310 sets online or offline state as appropriate with an appropriate (e.g., based on self-test results) substate.

The CREAM operational mode change sequences can be used to transition between the various operation models. The sequences may vary, for example, by the operational mode being transitioned from and the operational mode being transitioned to. A sequence for transitioning from the offline-standby operation mode to the online-normal operation mode includes the COAM module 310 checking the current configuration and beginning cell activation processes for any cells on the small cell that should be active. The sequence may add a cell if the cell has not previously been added.

A sequence for gracefully transitioning from the online-normal operation mode to the offline-standby operation mode includes the COAM module 310 changing the system operational state to offline-releasing. The COAM module 310 signals the RRM module 320 to stop accepting UE traffic connections. This signaling may be issued for each cell managed by the small cell. The COAM module 310 signals the RRM module 320 to clear existing UE traffic from the managed cells.

For each connected UE, the RRM module 320 then attempts to find an alternate cell to handle that UE and initiates a handover procedure to transfer the UE to the alternate cell. For any remaining connected UEs that could not be handed-off to alternate cells, the RRM module 320 begins a network initiated connection close procedure with the UE. When there are no more UE connections on any managed cells, the RRM module 320 reports idle back to the COAM module 310.

After the COAM module 310 has been informed that all cells managed by the small cell are now idle, the COAM module 310 changes the operational state to offline-standby. For each managed cell, the COAM module 310 then begins the cell deactivation procedure.

A sequence for transitioning from the online-normal operation mode to the offline-standby operation mode (without gracefully ending connections) includes the COAM module 310 changing system operational state from online-normal to offline-standby. The COAM module 310 also commands the RRM module 320 to cease accepting new connections on a cell. This command may be issued for each cell managed by the small cell. The COAM module 310 then requests deactivation of all cells.

A sequence for restoring a factory configuration includes one of the OAM client modules sending restore command to the COAM module 310. The COAM module 310 switches the operational state to offline-updating. The COAM module 310 writes a factory configuration over the stored configuration. The COAM module 310 commands the main module 305 to exit the CREAM process. The system monitor module will then detect the CREAM process has exited and cause a reboot or reset.

A sequence for a software update includes the one of the OAM client modules sending a ‘Software Update’ command to the COAM module 310 via the COAM interface module 310. The COAM module 310 switches to the offline-updating mode (thereby causing any active cells to be disabled and connections to be dropped). The COAM module 310 reports the new operating mode to the OAM client. The COAM module 310 begins downloading a firmware image file, for example, a file indicated in the software update command. After download, the file may be decompressed (or other processing performed, for example, error checking) and stored in an appropriate location as a new image. The COAM module 310 updates boot-loader parameters to boot from the new image at the next startup. The COAM module 310 sets an indication to send a configuration notify on the next startup and begins the system reboot procedure.

A sequence for gracefully transitioning from the online operation mode to the reconfiguration mode can be used when a cell reconfiguration is to be performed and a ‘Graceful shutdown’ configuration setting of the managed cell is enabled. The sequence includes the COAM module 310 changing to the reconfiguration-graceful operation mode and commanding the RRM module 320 to stop accepting new connections and clear all traffic. Once the RRM module 320 signals that node activity has stopped the ‘Recofig immediately’ procedure is followed.

A sequence for transitioning from the online operation mode to the reconfiguration mode (without gracefully ending connections) can be used when a cell reconfiguration is to be performed and a ‘Graceful shutdown’ configuration setting of the managed cell is not enabled. The sequence includes the COAM module 310 changing to the reconfiguration operational mode and commanding the RRM module 320 to start the cell reconfiguration. The RRM module 320 passes the reconfiguration command to the radio interface module 370 where a Cell Delete followed by a Cell Setup is performed. The sequence concludes with the reconfigured cell being brought back online.

A cell reconfiguration sequence may also be initiated by an OAM client. The sequence begins when the COAM module 310 receives a cell configuration change from an OAM client. The COAM module 310 sends parameters to be set to the RRM module 320 and the radio interface module 370. The cell reconfiguration procedure is then executed. Additionally the COAM module 310, in an embodiment, starts a configuration file write timer. When the timer expires, the COAM module 310 rewrites the active configuration with the changes made.

Sequences are also used for performance monitoring, for example, gathering statistics. For example, a performance monitoring reset sequence may be used to reset and restart performance monitoring statistics. The performance monitoring reset sequence can be initiated in response to a request from an OAM client. The COAM module 310 notifies the associated CREAM modules to reset their statistics. In addition to resetting their internal statistics, some modules may cause reset of other statistics. For example, the RRM module 320 can reset the statistics in the radio protocol modules.

Example call processing sequences include sequences for handover, configuration lookup, UE attachment, UE release, and configuration updates.

Various handover sequences may be used depending, for example, on whether the handover is within one small cell or between small cells. A sequence for handover between small cells may be termed S1 handover based on use of the S1 interface. The S1 handover sequence may begin when the RRM module 320 decides to move a UE to a neighboring cell (e.g., triggered by UE measurements, load-balancing, or OAM operations). The RRM module 320 commands the MP module 340 to begin the handover procedure for that UE. The MP module 340 communicates with the associated radio interface module 370 (the one of the radio interface module associated with the radio module to which the UE is connected) to initiate handover. The radio interface module 370 packs and delivers a message to the radio module (protocol stack).

The radio module on the eNB managing the target cell sends a UE admission request to the radio interface module on the eNB managing the target cell. The radio interface module on the eNB managing the target cell unpacks and delivers the admission request to the RRM module on the eNB managing the target cell. The RRM module on the eNB managing the target cell accepts the incoming UE and sends an admission response to the radio interface module on the eNB managing the target cell. The RRM module on the eNB managing the target cell allocates and prepares resources for the incoming UE. The RRM module 320 may start a timer, and if the timer expires before the handover process completes, the RRM module then releases the prepared resources.

The radio interface module on the eNB managing the target cell forwards the admission response to the radio module on the eNB managing the target cell. The radio module notifies the radio interface module 370 (on the source small cell) that the handover is in progress (e.g., in an LTE system this is in response to the HANDOVER_COMMAND message on S1). The radio interface module 370 unpacks and delivers the handover start message to the MP module 340. The MP module 340 responds to the message from the radio module 390 with a response message. The radio interface module 370 packs and delivers the response to the radio module 390. The radio module informs the radio interface module on the target eNB that the handover has completed (UE is now using the new cell).

The radio module 390 delivers UE release request to the source small cell. The radio interface module 370 on the source small cell unpacks and delivers the UE release request to the RRM module 320. The radio interface module on the target eNB unpacks and delivers a handover completion indication to the RRM module. The RRM module 320 on the source small cell acknowledges UE release. The RRM module on the target eNB stops handover timer. The radio interface module 370 packs and delivers the UE release response.

The RRM module 320 on the source small cell indicates handover completion to the MP module 340. The RRM module 320 on the source small cell starts a UE session timer (to hold on to the UE session in case the UE is handed back to the source small cell quickly). After the UE session timer expires, the RRM module 320 in the source small cell deletes the UE session and the handover sequence is completed.

A sequence for handover between cells managed by the small cell can be essentially similar to the sequence for S1 handover with the source and target cells being within the small cell.

A sequence for lookup of configuration of another eNB can be used to obtain information about the configuration of another eNB. The sequence may be termed an S1 eNB configuration lookup. The CNIPM module 330 can start this procedure by performing an internal database lookup for a desired eNB. If the desired eNB is found, the stored information for the eNB is used; otherwise, the CNIPM module 330 sends an eNB configuration transfer request message to the radio interface module 370. The radio interface module 370 builds an S1AP Configuration Transfer request message and delivers it to an active radio protocol stack with an S1 link to the MME for the desired eNB.

S1 eNB configuration transfer request arrives at the target eNB and is delivered to the radio interface module. The radio interface module sends the configuration transfer request to the CNIPM module. The CNIPM module responds with its transport network information. The radio interface module on the target eNB delivers the response to the radio module.

The S1 response then arrives at the requesting eNB. The radio interface module 370 on the requesting eNB delivers the response to the CNIPM module 330. The CNIPM module 330 stores the received transport network information in the local database and the information can be used to satisfy the internal database lookup.

A sequence for UE attachment may begin when a connection request is received from the UE. The radio module 390 then generates an admission request. The radio interface module 370 sends admission request from the radio module to the RRM module 320. The RRM module 320 accepts the new UE. The RRM module 320 also allocates a session object to track the new UE. The RRM module 320 sends an admission response to the radio interface module 370 indicating admission of the new UE. The radio interface module 370 delivers the response message to the radio module 390.

The new UE generates a context setup request for MME. The radio module 390 chooses an MME and forwards NAS messages. When S1AP receives the UE capability message, the received information is indicated to the radio interface module 370. The radio interface module 370 unpacks and delivers UE capability indication to the RRM module 320. The radio module 390 sends radio bearer configuration request to the radio interface module 370. The radio interface module 370 unpacks and delivers the bearer configuration request to the RRM module 320. The RRM module 320 verifies that the requested data channel parameters can be met. A bearer setup response sent from the RRM module 320 to the radio interface module 370. The radio interface module 370 packs and delivers the response to the radio module 390. The radio module 390 completes the connection setup and sends confirmation message. The radio interface module 370 completes the sequence when it unpacks and delivers connection setup/configuration confirmation message to the RRM module 320.

A sequence for UE release may begin when release request is received from the radio module. The RRM module 320 can remove all resources associated with the UE and evaluate the new loaded state of the managed cell. If a change in load state has occurred, the RRM module 320 can notify the SON module 325 of the change.

The ‘X2 eNB Configuration Update’ procedure used by various sequences includes the CNIPM module 330 looping through the X2 peers of the managed cell and sending all current information about the managed cell to each of the X2 peers.

The small cell may perform an X2 cell present indication procedure that includes the CNIPM module 330 analyzing neighbors of peer cells whenever X2 setup indications or eNB Configuration Updates are received from the peer cells. All neighbors of the X2 peer are reported to the MP module 340 as Cell Present Indications. When Cell Present Indications are received, the MP module 340 updates a tracked cell graph as a persistent tracked cell with this information and evaluates any PCI conflicts which may arise, for example, using the PCI Change procedure. If the X2 peer has a neighbor removed, the MP module 340 is notified to release the persistence of the tracked cell.

Example self-organizing network sequences include sequences for physical cell identifier (PCI) change, automatic neighbor relations (ANR) (such as add new neighbor and add new hand-in source cell), and tracking area optimization, RACH optimization, mobility optimization. The SON module may also perform sequences for load balancing and for an inter-cell interference coordinator.

A sequence for PCI change may begin when the MP module 340 notifies the RRM module 320 of a PCI change. The RRM module 320 initiates the self-configuration procedure to reconfigure the cell with the associated radio module 390. The MP module 340 updates its cell graph with the new PCI information. The RRM module 320 informs the CNIPM module 330, through the SON module 325, that a managed cell has been updated. The CNIPM module 330 the makes a Configuration Update announcement over X2.

A sequence for adding a new neighbor may begin when the radio module 390 reports UE measurement message to the radio interface module 370. The radio interface module 370 unpacks and delivers the UE measurement to the RRM module 320. The radio interface module 370 also delivers the UE measurement to the MP module 340. If the measurement is for a cell that the MP module 340 is not already aware of and it does not include the EGCI for the cell, the MP module 340 requests the CGI from the RRM module 320.

The RRM module 320 requests the UE to scan for and report the global cell identifier. The radio interface module 370 packs and delivers the RRM module's measurement request to the radio module 390. The radio module 390 acknowledges the RRM module 320 request. The radio interface module 370 delivers measurement acknowledgment to the RRM module 320. The radio module 390 reports UE measurement. The radio interface module 370 delivers the measurement result (now containing EGCI) to the RRM module 320. The radio interface module 370 delivers the measurement result (now containing EGCI) to the MP module 340.

The MP module 340 adds the new cell to the neighbor list of the serving cell. The MP module 340 informs the RRM module 320 of the new cell and new neighbor relationship. The MP module 340 informs the CNIPM module 330 of the new cell and new neighbor relationship. The CNIPM module 330 informs the SON module 325 of the new neighbor relationship. The CNIPM module 330 performs a database lookup for the eNB transport network configuration information. If needed, the CNIPM module 330 begins the S1 eNB lookup process to get that information (e.g., using S1-eNB configuration Lookup MSC). If the cell is associated with a new eNB peer, the CNIPM module 330 sets up the necessary X2 connections, for example, using the ‘Add eNB Peer’ procedure.

A sequence for adding a hand-in source cell may begin when the MP module 340 receives a handoverAdmissionIndication from a source cell that is not a neighbor of the target managed cell. The MP module 340 adds the source cell to the neighbor list of the target cell and notifies the RRM module and the CNIPM module of the new neighbor. The CNIPM module notifies the SON module 325 and performs a database lookup for the eNB transport network configuration information. If needed, the CNIPM module 330 begins an S1 eNB lookup process to get the information (e.g., using S1-eNB configuration Lookup MSC). If the cell is associated with a new eNB peer, the CNIPM module 330 sets up the necessary X2 connections, for example, using the ‘Add eNB Peer’ procedure.

The SON module 325 may include a tracking area optimizer function. The tracking area optimizer periodically receives Handover Reports, RACH and Paging statistics from the RRM module 320. As the statistics are received, they are filtered and processed by the tracking area optimizer. The tracking area optimizer monitors the trade-off between RACH usage and Paging channel usage to reduce (or in an embodiment minimize) the number of resources allocated to these overhead messages. When either of these resources becomes greatly overloaded the tracking area optimizer can modify the Tracking Area assigned to a managed cell. When selecting which tracking area code to use from multiple tracking areas, the tracking area optimizer may favor the tracking area with the highest volume of handover traffic.

The SON module 325 may include RACH optimizer function. The RACH optimizer receives local RACH statistics as inputs. The RACH optimizer processes the RACH statistics to tune the number of physical resources to dedicate for RACH operations per managed cell.

The SON module 325 may include mobility optimizer function. The mobility optimizer processes Radio Link Failure and Handover Reports generated by locally managed cells and remote X2 peer cells. The mobility optimizer collects statistics based on these reports and identifies neighbor relations that are causing high rates of failures. The mobility optimizer tunes the handover parameters to reduce these handover failure rates.

The SON module 325 uses resource status information, for example, in load balancer decisions. The CNIPM module 330 requests resource status updates from the X2 peers connected to a managed cell. When the resource status updates are received, the SON module 325 can use the information as input to the load balancer decision making.

The SON module 325 receives indications of local resource usage generated by the RRM module 320, the ERDSS (via the COAM module 310), and the radio module 390 (via the radio interface module 370). The local resource usage information is processed by the load balancer. The SON module 325 also forwards the resource usage information to the CNIPM module 330 which shares the information with the X2 peers of the managed cell. After generating any needed load balancing decisions, the SON module 325 evaluates the local resource usage (e.g., CPU, transport network, and resource capacity load levels) and may raise or clear appropriate alarms based on the usage.

The SON module 325 can also provide an inter-cell interference coordinator (ICIC). The ICIC processes uplink load information from local and remote cells. The ICIC compares the load levels of physical resource blocks (PRB) and allocates which PRBs are available to the local managed cells for use by UEs on the edge of coverage. Additionally, the CNIPM module 330 shares locally generated load information with each of the X2 peers of the managed cell.

The SON module 325 may begin a cell activation request sequence when a remote peer requests a cell to be activated. The load balancer in the SON module 325 analyzes the activation policy of the requested standby cell and determines if the activation request is allowed. If the request is allowed, the SON module can initiate the activation.

When the load balancer of the SON module 325 decides to bring a standby cell online, a cell activation sequence is executed. As described above, the cell activation sequence may vary depending on whether the resource to be activated is local to the small cell or remote.

The self-configuration procedure can be performed, for example, when the RRM module 320 receives a request from the SON module 325 or the MP module 340 to perform self-configuration. The RRM module 320 passes the changed information to the COAM module 310 and initiates the radio interface cell reconfiguration sequence.

The CREAM module 330 may also include a radio monitor module to monitor resource utilization (e.g., CPU load) of the radio modules. The radio monitor module periodically monitors the resource usage and reports the information, for example, via a L2L3_CPU_LOAD message, to the radio interface module 370. The radio interface module 370 decodes the message and generates an indication to the SON module 325. Upon reception of the load information, the SON module 325 can perform the local resource usage procedure.

The ERDSS may periodically monitor the transport network load of the system and report the information to the CREAM module 330, for example, in a TRANSPORT_NETWORK_LOAD_STATUS message. The COAM module 310 shall decode the load message and send the details to the SON module 325. Upon reception of the load information the SON module 325 shall perform the local resource usage procedure.

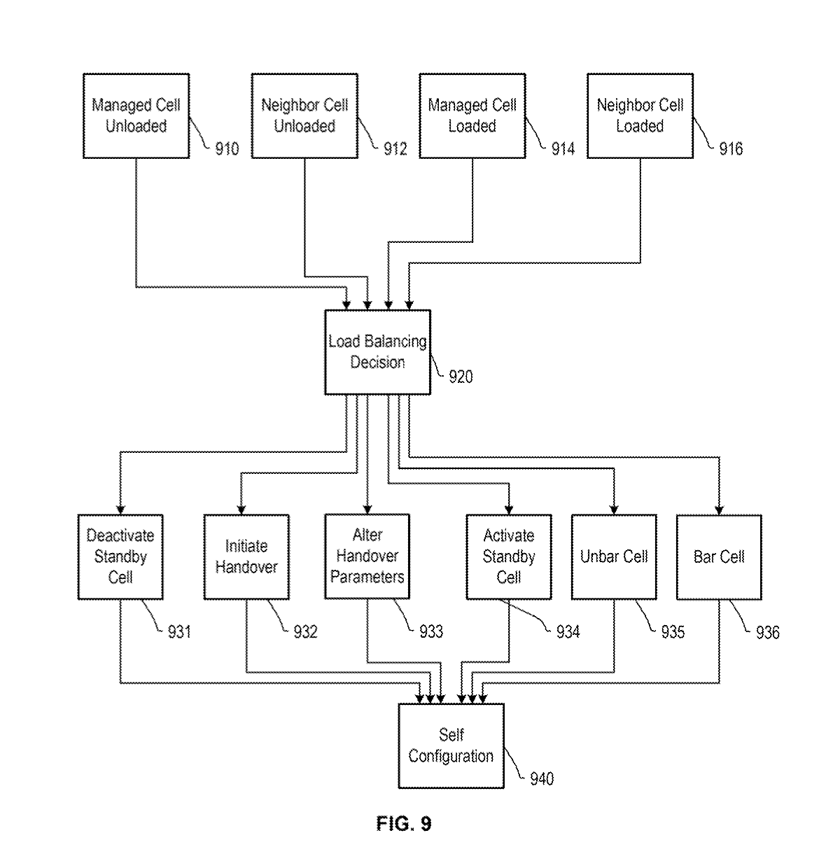

FIG. 9 is a flow diagram illustrating load balancing decisions in accordance with aspects of the invention. Many of the above functions, operations, and sequences and their relationships are shown. The load balancer of the SON module 325 also receives various inputs based on resource status updates received from managed and neighbor cells. For example, the SON module 325 may receive an indication that a managed cell is unloaded 910, that a neighbor cell is unloaded 912, that a managed cell is loaded 914, that a neighbor cell is loaded 916. The SON module 325 uses the received information to make load balancing decisions 920. These inputs are, for example, compared with the states of the known cells to determine one or more proper actions to take. The load balancer decisions can include, for example, deactivating standby cells 630, activating standby cells 934, initiating UE handovers 932, altering handover parameters 933, barring cells 936 (e.g., prohibiting UEs from attaching to a cell), and unbarring cells 935 (e.g., allowing UEs to attach to a cell). After the load balancing decision is effected, the SON module 325 initiates the self-configuration procedure 940.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, units, blocks, modules, and steps have been described above generally in terms of their functionality. Whether such functionality is implemented as hardware or software depends upon the particular system and design constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module (or unit) executed by a processor, or in a combination of the two. A software module can reside in RAM memory, flash memory, ROM memory, EPROM memory, EEPROM memory, registers, hard disk, a removable disk, a CD-ROM, or any other form of machine or computer readable storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art.

### Acronyms and Abbreviations

The foregoing description uses many terms, acronyms, and abbreviations that are common in the arts related to wireless communications. To aid those who may be less familiar with the relevant arts in understanding the disclosed systems and methods, the table below lists definitions for many acronyms and abbreviations used in this application.

| Term/Acronym | Definition |
|---|---|
| ACS | Automatic Configuration System |
| API | Application Programming Interface |
| BSS | Base Station System |
| CDMA | Code Division Multiple Access |
| CNIPM | Core Network and Inter-Cell Management |
| CNM | Core Network Management |
| eNB | Evolved Node B |
| ECGI | Enhanced Cell Global Identity |
| EPC | Evolved Packet Core |
| ERDSS | External Radio Device Support System |
| FAPI | Femto Application Platform Interface |
| GUI | Graphical User Interface |
| HOM | Handover Margin |
| HSS | Home Subscriber Server |
| IPM | Inter Cell Management |
| IDE | Integrated Development Environment |
| LTE | Long Term Evolution |
| MME | Mobility Management Entity |
| MP | Mobility Processor |
| NMM | Network Monitor Mode |
| NMS | Network Management System |
| OAM | Operations, Administration, and Maintenance |
| OAM-GUI | Operations, Administration, and Maintenance |
| | Graphical UI |
| OAM-TR069 | Operations, Administration, and Maintenance Processing |
| OAM-TUI | Operations, Administration, and Maintenance Textual UI |
| P-GW | Packet Gateway |
| PCI | Physical Cell Identity |
| PRACH | Physical Random Access Channel |
| PRB | Physical Resource Block |
| QoS | Quality of Service |
| RAB | Radio Access Bearer |
| RACH | Random Access Channel |
| RAT | Radio Access Technology |
| RF | Radio Frequency |
| RRC | Radio Resource Control |
| S-GW | Servicing Gateway |
| SCM | Source Code Management |
| SDD | Software Design Description |
| SDP | Software Development Plan |
| SGSN | Serving GPRS Support Node |
| SON | Self-Organizing Network |
| SRS | Software Requirements Specification |
| S1AP | S1 Application |
| TAI | Tracking Area Identity |
| TUI | Terminal User Interface |
| TTT | Time-To-Trigger |
| UE | User Equipment |
| UML | Unified Modeling Language |
| UMTS | Universal Mobile Telecommunications Service |
| X2AP | X2 Application |

What is claimed is:

1. A base station, comprising:
one or more radio modules operable to establish wireless communications with user equipments using one or more managed cells;
a backhaul interface module configured to send data to a core network and receive data from the core network;
a common radio element application manager (CREAM) module configured to manage communications between the user equipments and the core network via the radio modules and the backhaul interface, the CREAM module comprising:
one or more radio interface modules for managing communications with the one or more radio modules;
a radio resource manager module for managing resource of the one or more radio modules and for providing call admission decisions;
a mobility processor module for carrying out handover operations to move communications with the user equipments between cells;
a core network and inter-cell management module for managing communication with core network nodes and for managing functions between the base stations and other base stations nodes; and
a self-organizing network module for configuring and optimizing network operations of the base station.

2. The base station of claim 1, wherein the plurality of radio modules are operable to establish wireless communications with the user equipments using any of a plurality of communication protocols.

3. The base station of claim 2, wherein the plurality of radio modules are operable to establish wireless communications with the user equipments using any of a plurality of frequencies.

4. The base station of claim 1, wherein the self-organizing network module is further arranged for managing load balancing of communications with the user equipments between the radio modules.

5. The base station of claim 1, wherein the self-organizing network module is further arranged for providing inter-cell interference coordination.

6. The base station of claim 5, wherein the inter-cell interference coordination includes allocation of physical resource blocks for use in communicating with one the user equipments near an edge of coverage by the base station.

7. The base station of claim 1, wherein the CREAM module further includes a network monitor mode module for interfacing with physical layer modules used for the wireless communications with user equipments.

8. The base station of claim 1, wherein the CREAM module further includes an operations, administration, and maintenance (OAM) module for managing configuration and monitoring requests from external systems.

9. The base station of claim 1, further comprising a system monitor module for monitoring operations of the CREAM module, the system monitor module including: an event logger module for collecting log messages for the CREAM modules; and a watchdog timer module for detecting improper operation of the CREAM module and triggering a reboot operation.

10. The base station of claim 1, wherein the CREAM module is further configured to perform resource management sequences to activate the managed cells and to deactivate the managed cells.

11. The base station of claim 1, wherein the CREAM module is further configured to performs operational control sequences to change operational states of the base stations.

12. The base station of claim 11, wherein the operational states include an initializing state wherein the CREAM module loads configuration files and initialize base station modules, an offline state wherein the one or more managed cells are not active, and an online state for normal operations of the base station.

13. The base station of claim 12, wherein the operational states further include a releasing state wherein the base station gracefully all of the user equipments that are served by the base station.

14. The base station of claim 1, wherein the CREAM module is further configured to perform call processing sequences for handover of one of the user equipments, for attachment of one of the user equipments, and for release of one of the user equipments.

15. The base station of claim 1, wherein the CREAM module is further configured to perform self-organizing network sequences for load balancing and tracking area optimization.

16. The base station of claim 15, wherein the CREAM module is further configured to perform a self-organizing network sequences for inter-cell interference coordination.

17. A base station, comprising:
one or more radio modules, each of the radio modules operable to establish wireless communications with user equipments using one or more managed cells;
a backhaul interface module configured to send data to a core network and receive data from the core network;
a processor; and
a memory coupled to the processor and storing instructions for execution by the processor, the instructions comprising:
one or more radio interface modules for managing communications with the one or more radio modules;
a radio resource manager module for managing resource of the one or more radio modules and for providing call admission decisions;
a mobility processor module for carrying out handover operations to move communications with the user equipments between cells;
a core network and inter-cell management module for managing communication with core network nodes and for managing functions between the base stations and other base stations nodes; and
a self-organizing network module for configuring and optimizing network operations of the base station.

18. The base station of claim 17, wherein the self-organizing network module is further for managing load balancing of communications with the user equipments between the radio modules.

19. The base station of claim 17, wherein the self-organizing network module is further arranged for providing inter-cell interference coordination including allocation of physical resource blocks for use in communicating with one the user equipments near an edge of coverage by the base station.

20. The base station of claim 17, wherein the wherein the instructions further comprise a network monitor mode module for interfacing with physical layer modules used for the wireless communications with user equipments.

21. The base station of claim 17, wherein the instructions further comprise an operations, administration, and maintenance (OAM) module for managing configuration and monitoring requests from external systems.

22. The base station of claim 17, wherein the instructions further comprise a system monitor module for monitoring operations of the processor, the system monitor module including: an event logger module for collecting log messages; and a watchdog timer module for detecting improper operation of the base station module and triggering a reboot operation.

23. The base station of claim 17, wherein the instructions further comprise instructions to perform resource management sequences to activate the managed cells and to deactivate the managed cells.

24. The base station of claim 17, wherein the instructions further comprise instructions to performs operational control sequences to change operational states of the base stations.

25. The base station of claim 24, wherein the operational states include an initializing state wherein the base station loads configuration files and initialize base station modules, an offline state wherein the one or more managed cells are not active, and an online state for normal operations of the base station.

26. The base station of claim 25, wherein the operational states further include a releasing state wherein the base station gracefully all of the user equipments that are served by the base station.

27. The base station of claim 17, wherein the CREAM module is further configured to perform call processing sequences for handover of one of the user equipments, for attachment of one of the user equipments, and for release of one of the user equipments.

28. The base station of claim 17, wherein the CREAM module is further configured to perform self-organizing network sequences for load balancing and tracking area optimization.

29. The base station of claim 28, wherein the CREAM module is further configured to perform a self-organizing network sequences for inter-cell interference coordination.
